(19) United States
(12) Patent Application Publication
(10) Pub. No.: US 2024/0247107 A1
(43) Pub. Date: Jul. 25, 2024

(54) CROSS-LINKABLE ORGANOSILOXANE-MODIFIED REACTION RESINS

(71) Applicant: Wacker Chemie AG, Munich (DE)

(72) Inventor: Detlev Ostendorf, Munich (DE)

(73) Assignee: Wacker Chemie AG, Munich (DE)

(21) Appl. No.: 18/564,657

(22) PCT Filed: Jun. 1, 2021
(86) PCT No.: PCT/EP21/64670

§ 371 Date: Nov. 28, 2023

(51) Int. Cl. C08G 77/04; C08J 5/00; C08L 83/04

(52) U.S. Cl. CPC C08G 77/045; C08J 5/00; C08L 83/04; C08J 2383/04

(57) ABSTRACT

A crosslinkable composition includes (A) at least one organic compound and (B) at least one linear organosiloxane of general formula. The at least one organic compound is free of siloxane units (=“≡Si—O—Si≡”) and has at least two reactive cyanate ester groups (=“N≡CO—”). The at least one linear organosiloxane is of a general formula RₐR¹_{b}SiO_{(4-a-b)/2} (I). The at least one linear organosiloxane consists of three to five units of formula (I).

The present invention relates to crosslinkable, organosiloxane-modified reaction resins having cyanate ester functional groups, to processes for the production thereof, and to vulcanizates and composites obtainable therefrom.

Epoxy (EP) resins and epoxy resin systems are used in numerous applications and have now become established in composite materials, for example in combination with glass fibers, carbon fibers or aramid fibers, as one of the most commonly used thermoset classes. In addition, the use of other organic resin systems such as cyanate ester resins (CE), bismaleimide resins (BMI), polyimide resins (PI), benzoxazine resins or phthalonitrile resins and mixed resin systems, such as bis(benzocyclobutenimide)bismaleimide, cyanate ester/epoxide or bismaleimide/triazine (BT resins) as matrix resins in fiber composite materials, for example in carbon-fiber-reinforced plastics (CFRP), for use in industry, automobile construction, and aerospace, has become increasingly important in recent years. Compared to epoxy resins, the polymer matrix resins based for example on CE, BMI or PI combine very good mechanical properties with high glass transition temperatures, high thermal resilience, and high long-term stability, which greatly expands the possible uses of these thermosets, especially in the high-temperature range. However, high-temperature thermoset systems based on CE resins also have drawbacks. During thermal curing, the reactive cyanate ester (—“N≡CO—”) groups trimerize to cyclic triazine rings, resulting in networks with high crosslinking density that have high mechanical stability, but also exhibit increased brittleness. Another significant disadvantage of CE resin systems is that the triazine thermoset network exhibits comparatively high water absorption and is rapidly degraded by moisture (hydrolytic degradation), resulting in a loss of mechanical properties. It would therefore be desirable to provide suitable modifiers for reducing water absorption for these resin systems already on the market, thus allowing the high-temperature thermosets obtainable therefrom to be used commercially in demanding composite material applications, preferably for the aerospace industry.

The use of siloxane-containing components for impact modification and for improving the thermal and dielectric properties of cyanate ester thermoset networks has already been described numerous times in the literature, but only little is known about the effect of siloxanes on water absorption.

In Polym. Adv. Technol. 2020, 31, 1245-1255, the authors show that linear siloxanes containing methyl and phenyl groups and having reactive ≡Si—OH or ≡Si—H groups copolymerizable with cyanate ester groups reduce the absorption of water by a vulcanized cyanate ester resin, 2,2′-bis(4-cyanatophenyl)propane. This study employed a short-chain trisiloxane containing methyl and phenyl groups and having reactive ≡Si—H groups (referred to as “Si—H”) and also a higher-molecular-weight poly(methylphenylsiloxane) having reactive ≡Si—OH groups (referred to as “Si—B”). Compared to unmodified cyanate ester resin, water absorption is reduced by “Si—H” only negligibly and by “Si—B” significantly. In patent specification CN 112111059, the authors claim also linear siloxanes substituted with methyl and/or phenyl groups without reactive groups as modifiers for cyanate ester resins, but no corresponding exemplary embodiments are described for this purpose; instead, as in the publication cited above, all that is shown is the influence of linear siloxanes having terminal reactive, silicon-bonded OH, H, or glycidyloxypropyl groups; the degree of polymerization of the siloxanes used in exemplary embodiments 1 to 4, as depicted in formula 2 and formula 5 in CN 112111059, is not disclosed, preventing further work here.

However, the use of linear silicones having reactive ≡Si—OH or ≡Si—H groups as modifiers for cyanate ester resins has a number of disadvantages: Firstly, the silanol (≡Si—OH) groups undergo elimination of water, for example according to the reaction equation described in the abovementioned literature on page 1251, FIG. 8 (D), which undergoes an undesirable reaction with the hydrolysis-sensitive cyanate ester groups that liberates amine and gaseous carbon dioxide, thereby causing blistering during the crosslinking reaction that results in porosity in the crosslinked material. Secondly, the reactive Si—OH or Si—H groups can copolymerize with the cyanate ester groups according to the reaction equations described in the abovementioned literature on page 1251, FIGS. 8 (C) and (E), thereby altering the network topology, which can have an adverse effect on properties such as the fracture toughness of the cured thermoset network. Furthermore, higher-molecular-weight polysiloxanes are poorly compatible with cured cyanate ester-thermoset networks, which means that curing of the cyanate ester resin results in macroscopically, i.e. visually, heterogeneous, cloudy to opaque vulcanizates that exude silicone in an undesirable manner and have adverse effects on water absorption.

It is an object of the present invention to modify organic resins having reactive cyanate ester groups in such a way that, after the shaping and curing process, thermosets having reduced water absorption and thus improved hydrolysis resistance and possibly improved fracture toughness and possibly improved dielectric properties are obtained, while the advantageous properties intrinsic to the thermosets, such as thermal dimensional stability, mechanical strength, thermooxidative stability, and chemical resistance, are largely retained in the thermosets modified in this way too.

This object is achieved according to the invention by using linear tri-, tetra- or pentasiloxanes substituted with methyl and phenyl groups and without reactive groups such as ≡Si—OH or ≡Si—H; these are preferably tri- or tetrasiloxanes that have very good miscibility with organic cyanate ester resins and that, after vulcanization with the crosslinked cyanate ester matrix (i.e. the triazine network), afford homogeneous/single-phase, transparent thermosets that exhibit no demixing, i.e. no weeping or exudation of the siloxane component from the vulcanizate. Compared to unmodified cyanate ester resins, the cyanate ester resins modified with the tri-, tetra- or pentasiloxanes of the invention have, after curing to form the thermoset, the characteristic feature of significantly reduced water absorption and thus greater resistance to hydrolytic decomposition. Surprisingly, it has been found that the siloxane modifiers of the invention reduce the absorption of water by vulcanized cyanate ester networks significantly more strongly than the prior-art siloxanes having reactive groups such as ≡Si—H or ≡Si—OH or higher-molecular-weight polysiloxanes.

The invention provides crosslinkable compositions comprising
(A) at least one organic compound free of siloxane units (=“≡Si—O—Si≡”) and having at least two reactive cyanate ester groups (=“N≡CO—”),
(B) at least one linear organosiloxane of general formula

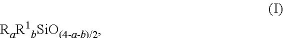

where
R may be identical or different and represents monovalent, SiC-bonded, saturated aliphatic hydrocarbon radicals,
R¹ may be identical or different and represents monovalent, SiC-bonded, optionally halogen- or phosphorus-substituted, aromatic hydrocarbon radicals,
a is 0, 1, 2 or 3, preferably 0, 1 or 2, more preferably 0 or 1, especially 1,
b is 0, 1, 2 or 3, preferably 0, 1 or 2, more preferably 1 or 2, with the proviso that
the organosiloxane (B) consists of three to five units of formula (I), preferably of three or four units of formula (I), more preferably of three units of formula (I); in formula (I) the sum a+b is equal to 2 or 3,
in each molecule of organosiloxane (B) the sum a+b is in two units of formula (I) equal to 3
and in each molecule of organosiloxane (B) there are at least three radicals R¹ present.

In the present disclosure, the designation “1-propenyl” denotes the “—CH═CH—CH₃” radical, “2-propenyl” (=allyl) the “—CH₂—CH═CH₂” radical, and the designation “propenyl” the 1- or 2-propenyl radical.

In order for the number of pages in the description in the present application not to be too excessive, only the preferred embodiments for individual features are specified.

However, the expert reader should explicitly understand this type of disclosure as meaning that every combination of different preference levels is also explicitly disclosed and explicitly desired—i.e. every combination both within a single compound/feature and between different compounds/features.

### Cyanate Ester Resin (A)

This is an organic compound free of siloxane units (=“≡Si—O—Si≡”) and having at least two reactive cyanate ester groups (=“N≡C—O—”) per molecule. Compound (A) may be substituted and may also contain heteroatoms. Compound (A) is preferably an optionally substituted, optionally heteroatom-containing aromatic hydrocarbon compound in which at least two cyanate ester groups attached to aromatic carbon atoms are present per molecule. Compound (A) particularly preferably contains per molecule at least two optionally substituted, optionally heteroatom-containing, aromatic hydrocarbon radicals, each containing a cyanate ester group attached to an aromatic carbon atom, more particularly in compound (A) the optionally substituted, optionally heteroatom-containing, aromatic hydrocarbon radicals, each containing a cyanate ester group attached to an aromatic carbon atom, are independently attached to one another via a covalent bond or at least one bridging unit containing at least one functional group selected from the group consisting of —CR²₂—, —CR²═CR²—, ═C═CR²₂, —O—, —S—, —N═N—, —CH═N—, —C(═O)—, —C(═O)O—, —OC(═O)O—, —SO—, —SO₂—, O═P(O—)₃, a divalent aromatic hydrocarbon radical such as phenylene, tolylene, biphenylene, and naphthylene; or a divalent cycloalkanediyl radical such as tricyclo[5.2.1.0^{2.6}]decanediyl and bicyclo[2.2.1]heptanediyl.

Radical R² is in each case independently a hydrogen atom, a halogen atom or an optionally substituted hydrocarbon radical having 1 to 30 carbon atoms, which may optionally be attached either to a substituent or to the other radical R² to form a cyclic unit.

Examples of optionally substituted hydrocarbon radicals R² are the methyl, ethyl, trifluoromethyl, fluorenyl, 1,1-cyclohexanediyl, 9H-fluorene-9,9-diyl, N-phenylphthalimide-3,3-diyl, 1(3H)-isobenzofuranone-3,3-diyl, anthracen-9(10H)-one-10,10-diyl, phenyl and 3,3,5-trimethylcyclohexane-1,1-diyl radical.

Examples of component (A) used according to the invention are di- and polycyanate esters of monoaromatic hydrocarbons, such as phenylene 1,2-dicyanate, phenylene 1,3-dicyanate (CAS 1129-88-0), phenylene 1,4-dicyanate (CAS 1129-80-2), 2,4,5-trifluorophenylene 1,3-dicyanate, 1,3,5-tricyanatobenzene, methyl (2,4-dicyanatophenyl)ketone, and 2,7-dicyanatonaphthalene; cyanate esters of bisphenols, such as 2,2-bis(4-cyanatophenyl)butane, 2,2-bis(4-cyanatophenyl)propane (CAS 1156-51-0, bisphenol A cyanate ester; trade names: AroCy® B10, PRIMASET® BADCy and CYTESTER® TA), 2,2-bis(4-cyanatophenyl)-1,1,1,3,3,3-hexafluoropropane (CAS 32728-27-1, bisphenol AF cyanate ester), 2,2-bis(3-methyl-4-cyanatophenyl)propane (bisphenol C cyanate ester), 1,1-bis(4-cyanatophenyl)ethane (CAS 47073-92-7, bisphenol E cyanate ester; trade names: AroCy® L-10, PRIMASET® LECy, CYTESTER® P201), 1,1-bis(4-cyanatophenyl)-1-phenylethane (bisphenol AP cyanate ester), bis(4-cyanatophenyl)methane (bisphenol F cyanate ester), bis(4-cyanato-3,5-dimethylphenyl)methane (CAS 101657-77-6, tetramethyl bisphenol F cyanate ester), 1,3-bis(2-(4-cyanatophenyl)propan-2-yl)benzene (CAS 127667-44-1, bisphenol M cyanate ester), bis(4-cyanatophenyl)thioether, bis(4-cyanatophenyl)ether, 9,9-bis(4-cyanatophenyl)fluorene (bisphenol FL cyanate ester), bis(4-cyanatophenyl)sulfone (bisphenol S cyanate ester), bis(4-cyanatophenyl)ketone, bis(4-(4-cyanatophenoxy)phenyl)ketone, bis(4-(4-cyanatophenoxy)phenyl)sulfone, bis(4-(4-cyanatophenoxy)phenyl)(phenyl)phosphine oxide, bis(4-cyanatophenyl)(methyl)phosphine oxide, 1,1-dibromo-2,2-bis(4-cyanatophenyl)ethylene, 1,1-dichloro-2,2-bis(4-cyanatophenyl)ethylene (CAS 14868-03-2), 3,3-bis(4-cyanatophenyl)-N-phenylphthalimide, 3,3-bis(4-cyanatophenyl)-1(3H)-isobenzofuranone, 3,3-bis(4-cyanatophenyl)-2-benzofuran-1-one, 10,10-bis(4-cyanatophenyl)anthracen-9(10H)-one, 1-ethyl-2-methyl-3-(4-cyanatophenyl)-5-cyanatoindane, 1,1-dimethyl-3-methyl-3-(4-cyanatophenyl)cyanatoindane, bis(2-cyanato-3-methoxy-5-methylphenyl)methane, and 1,1-bis(3-methyl-4-cyanatophenyl)cyclohexane (bisphenol Z cyanate ester); cyanate esters of propenyl-substituted bisphenols, such as bis(4-(4-(2-(3-(2-propenyl)-4-cyanatophenyl)propan-2-yl)phenoxy)phenyl) sulfone, 2,2-bis(3-(2-propenyl)-4-cyanatophenyl)propane, 2,2-bis(3-(1-propenyl)-4-cyanatophenyl)propane, and bis(4-(4-cyanato-3-(2-propenyl)phenoxy)phenyl) sulfone; cyanate esters of biphenyl, such as 4,4′-dicyanatobiphenyl (CAS 1219-14-3), 2,4′-dicyanatobiphenyl, and 2,2′-dicyanatobiphenyl; phenol-dicyclopentadiene cyanate ester resins, such as dicyclopentadienylbisphenol cyanate ester (CAS 135507-71-0; trade name: AroCy® XU-71787); cyanate esters of phenol-formaldehyde resins produced by acid- or alkali-catalyzed condensation of phenols, naphthols, naphthalenediols, xylenols or cresols with formaldehyde, for example resol cyanate esters or novolak cyanate esters (for example CAS 87397-54-4, CAS 153191-90-3, CAS 268734-03-8, CAS 30944-92-4, and CAS 173452-35-2; examples of trade names: Primaset® PT-15, PT-30, PT-60, PT-90 and CT-90, and also AroCy® XU-371); cyanate esters of fluoroalkanediols, such as 1,8-dicyanatoperfluorooctane; cyanate esters of naturally occurring polyphenols, such as trans-3,5,4′-tricyanatostilbene; cyanate esters of silanes having phenolic radicals, such as dimethylbis(4-cyanatophenyl)silane; 1,1,1-tris(4-cyanatophenyl)ethane (CAS 113151-22-7), 1,2,3-tris(4-cyanatophenyl)propane; and also end-terminated cyanate ester polymer resins composed of at least two identical or different repeat units, wherein the backbone of each repeat unit contains at least one divalent aromatic hydrocarbon radical, such as phenylene, biphenylene, and naphthylene, or 9H-fluorene-9,9-diyl, and at least one bridging unit selected from the group consisting of —CR³₂—, —CR³═CR³—, ═C═CR³—, —O—, —S—, —N═N—, —CH═N—, —C(═O)—, —C(═O)O—, —OC(═O)O—, —SO—, —SO₂—, O═P(O—)₃ or a divalent cycloalkanediyl radical, such as tricyclo[5.2.1.0^{2,6}]decanediyl and bicyclo[2.2.1]heptanediyl. Examples of repeat units in cyanate ester polymer resins are arylene ethers, arylene ether sulfones or arylene ether ketones.

Radical R³ is in each case independently the radicals recited for R².

Component (A) is preferably 2,2-bis(4-cyanatophenyl)propane, 1,1-bis(4-cyanatophenyl)ethane, bis(4-cyanatophenyl)methane, 1,3-bis(2-(4-cyanatophenyl)propan-2-yl)benzene, 2,2-bis(3-(2-propenyl)-4-cyanatophenyl)propane, bis(4-cyanatophenyl)thioether, bis(4-cyanatophenyl)sulfone, phenol-dicyclopentadiene cyanate ester resins or cyanate esters of phenol-formaldehyde resins. Component (A) is more preferably 2,2-bis(4-cyanatophenyl)propane, bis(4-cyanatophenyl)methane, 1,1-bis(4-cyanatophenyl)ethane, 1,3-bis(2-(4-cyanatophenyl)propan-2-yl)benzene, bis(4-cyanatophenyl)thioether, bis(4-cyanatophenyl)sulfone, phenol-dicyclopentadiene cyanate ester resins, and cyanate esters of phenol-formaldehyde resins. In particular, component (A) is 1,1-bis(4-cyanatophenyl)ethane, 1,3-bis(2-(4-cyanatophenyl)propan-2-yl)benzene or novolak cyanate esters of cresol or phenol.

It is possible to use just one cyanate ester resin (A) or a mixture of different cyanate ester resins (A); it is also possible to use prepolymers of one cyanate ester resin (A) or prepolymers of different cyanate ester resins (A) or else mixtures of cyanate ester resin prepolymers or mixtures of cyanate ester resin prepolymers with one or more cyanate ester resins (A).

An example of a prepolymer of a cyanate ester resin (A) is bisphenol A dicyanate homopolymer (CAS 25722-66-1).

Component (A) is preferably a mixture of cyanate esters of phenolic resins with further components (A); more preferably component (A) is a mixture of phenol novolak cyanate ester or cresol novolak cyanate ester with 1,1 bis(4-cyanatophenyl)ethane.

After curing, components (A) and (B) preferably form macroscopically homogeneous/single-phase thermosets that do not exhibit any demixing, i.e. weeping or exudation of the siloxane component (B) from the vulcanizate, and that are more preferably transparent.

### Compound(B)

(B) is a linear organosiloxane of general formula (I) as described hereinabove. Organosiloxane (B) may be solid or liquid at 23° C. and 1013 hPa, the liquid form being preferred.

Organosiloxane (B) preferably has a boiling point higher than 300° C., preferably higher than 400° C., more preferably higher than 500° C., in particular higher than 550° C., in each case at 1013 hPa.

Examples of monovalent, SiC-bonded, saturated aliphatic hydrocarbon radicals R are alkyl radicals, such as the methyl, ethyl, n-propyl, isopropyl, 1-n-butyl, 2-n-butyl, isobutyl, tert-butyl, n-pentyl, isopentyl, neopentyl and tert-pentyl radical, the n-hexyl, n-heptyl, n-octyl, 2,4,4-trimethylpentyl, 2,2,4-trimethylpentyl, 2-ethylhexyl, n-nonyl, n-decyl, n-dodecyl, n-hexadecyl, and n-octadecyl radical; and cycloalkyl radicals, such as the cyclopentyl, cyclohexyl, cycloheptyl, and methylcyclohexyl radical.

Radical R is preferably a monovalent, SiC-bonded hydrocarbon radical having 1 to 8 carbon atoms, more preferably methyl.

Examples of monovalent, SiC-bonded aromatic, optionally substituted hydrocarbon radicals R¹ are aryl radicals, such as the phenyl, biphenyl, naphthyl, anthryl and phenanthryl radical; alkaryl radicals, such as o-, m-, p-tolyl radicals; xylyl radicals and ethylphenyl radicals; aralkyl radicals, such as the benzyl radical, (9,10-dihydro-9-oxa-10-phosphaphenanthrene-10-oxide-10-yl)ethyl radical, the α- and β-phenylethyl radical; and haloaryl radicals, such as the fluorophenyl, chlorophenyl, and bromophenyl radicals.

Radical R¹ is preferably a halogen- and phosphorus-free aromatic hydrocarbon radical, more preferably phenyl.

The organosiloxanes (B) used according to the invention preferably consist of three to five units of formula (I) in which at least four radicals R¹ are present per molecule of (B).

The organosiloxanes (B) used according to the invention preferably consist of three to four units of formula (I) in which at least four radicals R¹ are present per molecule and b≠0 in each unit of formula (I) where a+b=2.

The organosiloxanes (B) used according to the invention more preferably consist of three or four units of formula (I) in which at least four radicals R¹ are present per molecule and b≠0 in each unit of formula (I).

The organosiloxanes (B) used according to the invention consist in particular of three units of formula (I) in which at least five radicals R¹ are present per molecule and b≠0 in each unit of formula (I).

Examples of component (B) used according to the invention are 1,3,5-trimethyl-1,1,3,5,5-pentaphenyltrisiloxane (CAS 3390-61-2), 1,1,3,5,5-pentamethyl-1,3,5-triphenyltrisiloxane, 1,5-dimethyl-1,1,3,3,5,5-hexaphenyltrisiloxane, 1,1,5,5-tetramethyl-1,3,3,5-tetraphenyltrisiloxane, 1,3,3,5-tetramethyl-1,1,5,5-tetraphenyltrisiloxane (CAS 3982-82-9), 1,1,1-triphenyl-3,3,5,5,5-pentamethyltrisiloxane, 1,1,1,5,5,5-hexaphenyl-3,3-dimethyltrisiloxane, 3-methyl-1,1,1,3,5,5,5-heptaphenyltrisiloxane, 1,3,5,5,5-pentamethyl-1,1,3-triphenyltrisiloxane, 1,1,3,5-tetramethyl-1,3,5,5-tetraphenyltrisiloxane, 1,3,5,7-tetramethyl-1,1,3,5,7,7-hexaphenyltetrasiloxane (CAS 38421-40-8), 1,1,3,5,7,7-hexamethyl-1,3,5,7-tetraphenyltetrasiloxane, 1,1,1,7,7,7-hexamethyl-3,3,5,5-tetraphenyltetrasiloxane, 1,3,3,5,5,7-hexamethyl-1,1,7,7-tetraphenyltetrasiloxane (CAS 6904-66-1), decaphenyltetrasiloxane, 1,7-dimethyl-1,1,3,3,5,5,7,7-octaphenyltetrasiloxane, 1,1,7,7-tetramethyl-1,3,3,5,5,7-hexaphenyltetrasiloxane, 1,3,5,5,7-pentamethyl-1,1,3,7,7-pentaphenyltetrasiloxane, 1,1,1,5,7,7,7-heptamethyl-3,3,5-triphenyltetrasiloxane, 1,1,3,7,7-pentamethyl-1,3,5,5,7-pentaphenyltetrasiloxane, 1,3,5,7,7,7-hexamethyl-1,1,3,5-tetraphenyltetrasiloxane, 1,3,5,7,9-pentamethyl-1,1,3,5,7,9,9-heptaphenylpentasiloxane, 1,1,9,9-tetramethyl-1,3,3,5,5,7,7,9-octaphenylpentasiloxane, dodecaphenylpentasiloxane, 1,3,3,5,5,7,7,9-octamethyl-1,1,9,9-tetraphenylpentasiloxane (CAS 18758-39-9), 1,1,1,3,5,7,9,9,9-nonamethyl-3,5,7-triphenylpentasiloxane (CAS 6689-19-6), 1,1,1,9,9,9-hexamethyl-3,3,5,5,7,7-hexaphenylpentasiloxane, 1,1,3,5,7,9,9-heptamethyl-1,3,5,7,9-pentaphenylpentasiloxane, and 1,1,3,5,7,9,9,9-octamethyl-1,3,5,7-tetraphenylpentasiloxane, with preference given to 3-methyl-1,1,1,3,5,5,5-heptaphenyltrisiloxane, 1,3,5-trimethyl-1,1,3,5,5-pentaphenyltrisiloxane, 1,1,3,5-tetramethyl-1,3,5,5-tetraphenyltrisiloxane, 1,1,3,5,7,7-hexamethyl-1,3,5,7-tetraphenyltetrasiloxane, 1,3,5,7-tetramethyl-1,1,3,5,7,7-hexaphenyltetrasiloxane, and 1,1,1,7,7,7-hexamethyl-3,3,5,5-tetraphenyltetrasiloxane, further preference given to 1,3,5-trimethyl-1,1,3,5,5-pentaphenyltrisiloxane, 1,1,3,5,7,7-hexamethyl-1,3,5,7-tetraphenyltetrasiloxane, and 1,3,5,7-tetramethyl-1,1,3,5,7,7-hexaphenyltetrasiloxane, and particular preference given to 1,1,3,5,5-pentaphenyl-1,3,5-trimethyltrisiloxane.

It is possible to use just one organosiloxane (B) or a mixture of different organosiloxanes (B).

If organosiloxane (B) is a mixture of different organosiloxanes (B), the weight-average molar mass Mw is preferably 400 g/mol to 1000 g/mol, preferably 420 g/mol to 900 g/mol, more preferably 480 g/mol to 750 g/mol, in particular 510 g/mol to 650 g/mol.

If organosiloxane (B) is a mixture of different organosiloxanes (B), the number-average molar mass Mn is preferably 300 g/mol to 990 g/mol, preferably 350 g/mol to 890 g/mol, more preferably 400 g/mol to 740 g/mol, in particular 450 g/mol to 640 g/mol.

The compositions of the invention contain organosiloxane (B) in amounts of preferably 1 to 100 parts by weight, more preferably 5 to 50 parts by weight, in particular 5 to 35 parts by weight, in each case based on 100 parts by weight of component (A).

In addition to components (A) and (B) the compositions of the invention may comprise further substances different from components (A) and (B), for example modifier (C), reactive resin (D), filler (E), curing accelerator (F), solvent (G), and further constituents (H).

### Compound (C)

The optionally used modifiers (C) are organosilicon compounds (C1) that are different from component (B) and contain units of formula

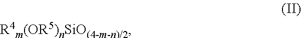

where
R⁴ may be identical or different and represents a hydrogen atom or monovalent or divalent, SiC-bonded, optionally substituted, optionally heteroatom-containing hydrocarbon radicals,
R⁵ may be identical or different and represents a hydrogen atom or monovalent, optionally substituted, optionally heteroatom-containing hydrocarbon radicals having 1 to 18 carbon atoms,
m is 0, 1, 2 or 3, preferably 1, 2 or 3,
n is 0, 1, 2 or 3, preferably 0, 1 or 2, more preferably 0 or 1, in particular 0, and with the proviso that in formula (II) the sum m+n is ≤3,
and with the proviso that they do not at the same time come under the definition of linear organopolysiloxanes (B).

Examples of monovalent, SiC-bonded, optionally substituted, optionally heteroatom-containing hydrocarbon radicals R⁴ are the radicals recited for R and R¹; hydrocarbon radicals having aliphatic carbon-carbon multiple bonds, such as the vinyl, 1-propenyl, 2-propenyl, vinylcyclohexyl, norbornenyl, norbornenylethyl, bicyclo[2.2.1]hept-5-en-2-yl, dicyclopentenyl, cyclohexenyl, 4-vinylphenyl, styryl, arylethynyl, ethynylphenyl, 1-propenylphenyl, and 2-propenylphenyl radical; imido radicals, such as the N-(5-ethynylphthalimido)phenyl, N-(5-(phenylethynyl)phthalimido)phenyl, nadimidophenyl, maleimidophenyl, and 3-maleimidopropyl radical; epoxy radicals, such as the 3-glycidoxypropyl, 4-(oxiran-2-yl)phenyl, oxiran-2-yl, and 2-(3,4-epoxycyclohexyl)ethyl radical; acrylate and methacrylate radicals, such as the 3-methacryloyloxypropyl, acryloyloxymethyl, and methacryloyloxymethyl radical; amine radicals, such as the aminophenyl, 3-aminopropyl, N-(2-aminoethyl)-3-aminopropyl, and N-phenylaminomethyl radical; hydroxyalkyl and hydroxyaryl radicals, such as the hydroxypropyl, hydroxyphenyl, and (4-hydroxy-3-propenyl)phenyl radical; and also the bicyclo[4.2.0]octa-1,3,5-trienyl (=benzocyclobutenyl), cyanatophenyl, isocyanatophenyl, polycaprolactonylamidopropyl, polycaprolactamylamidopropyl, and 3-isocyanatopropyl radical.

Examples of divalent, SiC-bonded, optionally substituted, optionally heteroatom-containing hydrocarbon radicals R⁴ are the phenylene and biphenylene radical, which preferably connect together two units of formula (II).

Radical R⁴ is preferably a hydrogen atom or the phenylene, phenyl, methyl, hydroxyphenyl, maleimidophenyl, cyanatophenyl, and aminophenyl radical, more preferably the methyl, phenyl, and hydroxyphenyl radical.

Radical R⁵ is preferably the methyl, ethyl, n-propyl, isopropyl, n-butyl, sec-butyl, tert-butyl or isobutyl radical, more preferably the methyl or ethyl radical.

Examples of organosilicon compounds(C1) are 1,3,5,7-tetrakis(2-(3,4-epoxycyclohexyl)ethyl)-1,3,5,7-tetramethylcyclotetrasiloxane (CAS 121225-98-7), bis[2-(3,4-epoxycyclohex-1-yl)ethyl]-1,1,3,3-tetramethyldisiloxane (CAS 18724-32-8), 1,3-bis(norbornenylethyl)-1,1,3,3,-tetramethyldisiloxane, 2,4,6,8-tetramethyl-2,4,6,8-tetrakis[3-(glycidoxy)propyl]cyclotetrasiloxane (CAS 257284-60-9), organopolysiloxanes of average composition (PhSiO_{3/2})₂₀(PhSi(OMe)O_{2/2})₆₆(PhSi(OMe)₂O_{1/2})₁₄ and of average molar mass Mw=2190 g/mol, and organopolysiloxanes of the average composition (PhSiO_{3/2})₇₅(Me₃SiO_{1/2})₂₅ and of average molar mass Mw=1380 g/mol, octa(epoxycyclohexyl)-POSS (CAS 187333-74-0), octaphenyl-POSS (CAS 5256-79-1), octaphenylcyclotetrasiloxane (CAS 546-56-5), 2,4,6,8-tetramethyl-2,4,6,8-tetraphenylcyclotetrasiloxane (CAS 77-63-4), 1,1,3,3-tetramethyl-5,5,7,7-tetraphenylcyclotetrasiloxane (CAS 1693-47-6), and 1,9-dimethoxy-1,3,5,7,9-pentamethyl-1,3,5,7,9-pentaphenylpentasiloxane.

The optionally used modifiers (C) also include thermoplastic organic polymers (“thermoplastics”) (C2) that are free of cyanate ester groups and of ≡Si—O—Si≡ siloxane units and that have at least two repeat units selected from the group consisting of polyarylenes, polyarylene ethers, polyarylenesulfides, polysulfones, polyethersulfones, polyetherketones, polyetheretherketones, polyetherketoneketones, polyetheretherketoneketones, polyimides, polybenzimidazoles, polyamides, poly(amideimides), polyarylates, polyesterimides, polyetherimides, polyaramids, polyacrylates, polyhydantoins, liquid-crystal polymers, polycarbonates, polyestercarbonates and polyethylene terephthalates; and also mixtures or copolymeric compounds thereof. The thermoplastics (C2) have either reactive end groups or chemically inert end groups. In the polymerization reaction, as a consequence of production, reactive end groups remain from the corresponding reactive groups of the monomers. These groups are preferably hydroxy, amino, carboxy or isocyanato groups. Examples of chemically inert end groups are methyl or phenyl radical. The thermoplastics (C2) have glass transition temperatures above 100° C., preferably of 130° C. to 450° C., more preferably of 150° C. to 400° C., in particular of 180° C. to 350° C.; the number average molar mass Mn of (C2) is preferably from 1100 to 100 000 g/mol, preferably 2000 to 50 000 g/mol, more preferably 2000 to 30 000 g/mol, in particular 3000 to 20 000 g/mol.

The optionally used modifiers (C) also include organic monofunctional cyanate esters (C3) free of siloxane units (≡Si—O—Si≡) and having the general formula

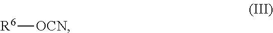

where R⁶ represents a monovalent, optionally substituted, optionally heteroatom-containing aromatic hydrocarbon radical, with the proviso that the cyanate ester group is directly attached to an aromatic carbon atom. Examples of suitable components (C3) are cyanatobenzene (CAS 1122-85-6), 1-cyanato-4-cumylbenzene (CAS 110215-65-1), 1-cyanato-4-tert-butylbenzene, 1-cyanato-2-tert-butylbenzene, 4-cyanatobiphenyl, 1-cyanatonaphthalene, 2-cyanatonaphthalene, 4-cyanatononylbenzene, 4-chlorocyanatobenzene, 4-cyanatodiphenylsulfone, 4-cyanatotoluene, 4-cyanatodiphenyl ether, 4-cyanatodiphenyl ketone, 4-(cyanato)methoxybenzene; and also propenyl-substituted monofunctional cyanate esters, such as 2-(2-propenyl)cyanatobenzene or 2-(1-propenyl)cyanatobenzene.

The modifiers (C3) preferably have a boiling point at 1013 hPa of at least 150° C., more preferably at least 180° C., in particular at least 220° C.

The optionally used modifiers (C) also include monomeric aromatic hydroxy compounds (C4) that are free of siloxane (≡Si—O—Si≡) units and that, aside from the OH groups, may contain as further reactive units only aliphatic carbon-carbon multiple bonds able to undergo the polymerization reaction.

Any reactive aliphatic carbon-carbon multiple bonds present in modifier (C4) are preferably propenyl groups; more preferably, the hydroxy groups and any propenyl groups present in the modifier (C4) are directly attached to aromatic carbon atoms.

Examples of modifiers (C4) without reactive aliphatic carbon-carbon multiple bonds are monohydric, optionally substituted phenols, such as phenol, cresol, naphthol, biphenylol, thymol, guaiacol (2-methoxyphenol), 4-cumylphenol, 4-benzylphenol, 4-isopropylphenol, 4-tert-butylphenol, 2-tert-butylphenol, 2,4-di-tert-butyl phenol, 2,4-bis(α,α-dimethylbenzyl)phenol, nonylphenol, xylenol or 2,6-dinonylphenol; polyhydric phenols, such as catechol (benzene-1,2-diol), resorcinol (benzene-1,3-diol), hydroquinone (benzene-1,4-diol), pyrogallol (benzene-1,2,3-triol), phloroglucinol (benzene-1,3,5-triol), dihydroxynaphthalene; aromatic compounds containing two (=“bisphenols”) or more hydroxyphenyl radicals, such as bis(2-hydroxyphenyl)methane, 2,2-bis(3-methyl-4-hydroxyphenyl)propane (bisphenol C), 1,1-bis(4-hydroxyphenyl)ethane (bisphenol E), 2,2-bis(4-hydroxyphenyl)propane (bisphenol A), 2,2-bis(4-hydroxyphenyl)butane (bisphenol B), 2,2-bis(4-hydroxyphenyl)hexafluoropropane (bisphenol AF), 9,9-bis(4-hydroxyphenyl)fluorene (bisphenol FL), bis(4-hydroxyphenyl)sulfone (bisphenol S), 1,3-bis(2-(4-hydroxyphenyl)-2-propyl)benzene (bisphenol M), bis(4-hydroxyphenyl)methane (bisphenol F), bis(4-hydroxyphenyl)ether, bis(4-hydroxyphenyl)thioether, and 1,1,1-tris(4-hydroxyphenyl)ethane.

Examples of modifiers (C4) having propenyl groups are 2,2-bis(3-(2-propenyl)-4-hydroxyphenyl)propane (CAS 1745-89-7), 2-methoxy-4-(2-propenyl)phenol (CAS 97-53-0), 4-(2-propenyl)-2,6-dimethoxyphenol (CAS 6627-88-9), 2-(2-propenyl)-6-methylphenol (CAS 3354-58-3), 2-(2-propenyl)phenol (CAS 1745-81-9), 5,5′-bis(2-propenyl)-2,2′-biphenyldiol (CAS 528-43-8), 3′,5-bis(2-propenyl)-2,4′-biphenyldiol (CAS 35354-74-6), α,α′-bis(3-(2-propenyl)-4-hydroxyphenyl)-p-diisopropylbenzene, 2,2′-bis(3-(2-propenyl)-4-hydroxyphenyl)perfluoropropane, 9,9′-bis(3-(2-propenyl)-4-hydroxyphenyl)fluorene, α,α′-bis(3-(1-propenyl)-4-hydroxyphenyl)-p-diisopropylbenzene, 2,2′-bis(3-(1-propenyl)-4-hydroxyphenyl)perfluoropropane, 9,9′-bis(3-(1-propenyl)-4-hydroxyphenyl)fluorene, 4-{1-[4-hydroxy-3-(2-propenyl)phenyl]propyl}-2-(prop-2-en-1-yl)phenol, 1,1′-(1,3-phenylenedioxy)bis(3-(2-(2-propenyl)phenoxy)propan-2-ol) (CAS 110866-35-8), and bis(3-(2-propenyl)-4-hydroxyphenyl)sulfone (CAS 41481-66-7).

Preferred modifiers (C4) are biphenylol, 2-methoxy-4-(2-propenyl)phenol, 4-cumylphenol, 4-isopropylphenol, 4-tert-butylphenol, 2-tert-butylphenol, bisphenols, 1,1,1-tris(4-hydroxyphenyl)ethane, 2,2-bis(3-(2-propenyl)-4-hydroxyphenyl)propane, 4-{1-[4-hydroxy-3-(prop-2-en-1-yl)phenyl]propyl}-2-(prop-2-en-1-yl)phenol, 1,1′-(1,3-phenylenedioxy)bis(3-(2-(prop-2-enyl)phenoxy)propan-2-ol), and 2-(2-propenyl)phenol, with particular preference given to 2-methoxy-4-(2-propenyl)phenol, 4-cumylphenol 4-tert-butylphenol, 2,2-bis(3-(2-propenyl)-4-hydroxyphenyl)propane, 4-{1-[4-hydroxy-3-(prop-2-en-1-yl)phenyl]propyl}-2-(prop-2-en-1-yl)phenol, 1,1′-(1,3-phenylenedioxy)bis(3-(2-(prop-2-enyl)phenoxy)propan-2-ol), bis(3-(2-propenyl)-4-hydroxyphenyl)sulfone, and bisphenols B, E, F, M, and S.

If the compositions of the invention contain modifier (C), it is possible to use either just one modifier (C1) to (C4) or two or more different modifiers (C1) to (C4).

If the compositions of the invention contain modifier (C1), (C2) or (C3), the amounts used are in each case preferably 1 to 40 parts by weight, more preferably 1 to 30 parts by weight, in particular 1 to 20 parts by weight, in each case based on 100 parts by weight of the mixture of components (A) and (B).

If the compositions of the invention contain modifier (C4), the molar ratio of the sum of the cyanate ester groups present in the composition of the invention to the sum of the reactive hydroxy functional groups in component (C4) is preferably in the range from 60:40 to 99:1, more preferably from 70:30 to 95:5.

### Compound (D)

The optionally used reactive resins (D) include polymerizable organic compounds that are free of cyanate ester groups and siloxane (≡Si—O—Si≡) units and are selected from the group consisting of epoxides (D1) and imides (D2), with the proviso that epoxides (D1) contain per molecule at least two optionally substituted glycidyloxy, glycidyloxycarbonyl, glycidylamino, diglycidylamino or oxiranyl groups, preferably at least two such groups attached to aromatic carbon atoms; and that imides (D2) contain per molecule at least two optionally substituted 5-ethynylphthalimido, 5-(phenylethynyl)phthalimido, nadimido, benzocyclobutenephthalimido or maleimido groups, preferably at least two such groups attached to aromatic carbon atoms; with particular preference given to maleimido, glycidyloxy, glycidylamino, and diglycidylamino groups.

The optionally used reactive resins (D) preferably contain per molecule at least two optionally substituted, optionally heteroatom-containing, aromatic hydrocarbon radicals, each containing a maleimido, glycidyloxy, glycidyloxycarbonyl, glycidylamino or diglycidylamino group attached to an aromatic carbon atom. More preferably, (D) is a compound containing at least two optionally substituted, optionally heteroatom-containing, aromatic hydrocarbon radicals, each containing a maleimido, glycidyloxy, glycidylamino or diglycidylamino group attached to an aromatic carbon atom, wherein the optionally substituted, optionally heteroatom-containing, aromatic hydrocarbon radicals are attached to one another via a covalent bond or a bridging unit containing at least one functional group selected from the group consisting of —CR⁷₂—, —CR⁷═CR⁷—, —C═CR⁷₂, —O—, —S—, —N═N—, —CH═N—, —C(═O)—, —C(═O)O—, —OC(═O)O—, —S(O)₂—, O═P(O—)₃, phenylene, arylene, biphenylene, biarylene, naphthylene or cycloalkanediyl groups, such as tricyclo[5.2.1.0^{2.6}]decanediyl or bicyclo[2.2.1]heptanediyl.

Radical R⁷ is in each case independently the radicals recited for R².

Compound (D) preferably contains no heteroatom-containing aromatic hydrocarbon radicals.

Epoxy resins (D1) are preferably copolymerizable with cyanate ester resin (A).

Imide resins (D2) are preferably not copolymerizable with cyanate ester resin (A).

Examples of epoxy resins (D1) are glycidyl ethers of phenolic compounds, such as 2,2-bis(4-glycidyloxyphenyl)propane (CAS 1675-54-3), bis(4-glycidyloxyphenyl)methane (CAS 2095-03-6), 1,2-bis(glycidyloxy)benzene (CAS 2851-82-3), 1,3-bis(glycidyloxy)benzene (CAS 101-90-6), 1,4-bis(glycidyloxy)benzene (CAS 129375-41-3), 3,5,3′,5′-tetramethyl-4,4′-diglycidyloxybiphenyl (CAS 85954-11-6), 2,2-bis(3,5-dibromo-4-glycidyloxyphenyl)propane (CAS 3072-84-2), tris(4-glycidyloxyphenyl)methane (CAS 66072-38-6), 1,1,2,2-tetrakis(4-glycidyloxyphenyl)ethane (CAS 7328-97-4), 4,4′-bis(glycidyloxyphenyl)sulfone (CAS 878-43-1), 9,9-bis(4-glycidyloxyphenyl)fluorene (CAS 47758-37-2), 1,6-(diglycidyloxy)naphthalene (CAS 27610-48-6); glycidyl ethers of phenol-, naphthol-, naphthalenediol-, bisphenol- or cresol-formaldehyde condensation products, such as cresol novolak glycidyl ether (CAS 29690-82-2), phenol novolak glycidyl ether (CAS 9003-36-5, CAS 28064-14-4, CAS 158163-01-0), and bisphenol A-epichlorohydrin-formaldehyde copolymer (CAS 28906-96-9); glycidyl ethers of phenol- or cresol-dicyclopentadiene condensation products, such as CAS 68610-51-5 and CAS 119345-05-0; glycidyl esters of aromatic carboxylic acids, such as diglycidyl phthalate (CAS 7195-45-1), diglycidyl terephthalate (CAS 7195-44-0), diglycidyl isophthalate (CAS 7195-43-9), triglycidyl benzene-1,2,3-tricarboxylate, triglycidyl benzene-1,2,4-tricarboxylate (CAS 7237-83-4) and triglycidyl benzene-1,3,5-tricarboxylate (CAS 7176-19-4); glycidyl derivatives of aromatic amines and aminophenols, such as N,N-diglycidyl-4-glycidyloxyaniline (CAS 5026-74-4), 4,4′-methylenebis(N,N-diglycidylaniline) (CAS 28768-32-3), N,N,N′,N′-tetraglycidyl-4,4′-diamino-3,3′-diethyldiphenylmethane (CAS 130728-76-6), and m-(glycidyloxy)-N,N-diglycidylaniline (CAS 71604-74-5); glycidyl end-terminated thermoplastic polymers producible for example by reaction of amino- or hydroxy-terminated thermoplastics (C2) with epichlorohydrin, such as glycidyloxy- or diglycidylamino-end-terminated polysulfones; homopolymeric or copolymeric epoxy resins, such as bisphenol A-epichlorohydrin copolymer (CAS 25036-25-3), 2,2′,6,6′-tetrabromobisphenol A-epichlorohydrin copolymer (CAS 40039-93-8), and reaction products of diglycidylbisphenol A with m-phenylenebis(methylamine) (CAS 110839-13-9); and mixtures of different epoxy resins (D1).

Examples of polymerizable maleimide resins (D2) are 4,4′-bis(maleimidophenyl)methane (CAS 13676-54-5), m-xylylenebismaleimide (CAS 13676-53-4), 1,1′-(2,2,4-trimethylhexane-1,6-diyl)bis-1H-pyrrole-2,5-dione (CAS 39979-46-9), bis(3-ethyl-5-methyl-4-maleimidophenyl)methane (CAS 105391-33-1), bis(4-maleimido-3-methylphenyl)methane, bis(4-maleimido-3,5-dimethylphenyl)methane, 1,1-bis(4-maleimidophenyl)cyclohexane, 2,4-bismaleimidotoluene (CAS 6422-83-9), N,N′-1,2-phenylenebismaleimide (CAS 13118-04-2), N,N′-1,3-phenylenebismaleimide (CAS 3006-93-7), N,N′-1,3-phenylenebismaleimide (CAS 3278-31-7), copolymers of bismaleimides and aromatic amines such as 4,4′-bis(maleimidophenyl)methane/4,4′-bis(aminophenyl)methane copolymer (CAS 26140-67-0); the reaction product with maleic anhydride of a condensation product of formaldehyde and aniline (CAS 28630-26-4, CAS 67784-74-1); bis(4-maleimidophenyl)ether, 2,2-bis[4-(maleimidophenoxy)phenyl]propane (CAS 79922-55-7), bis(4-maleimidophenyl)sulfone (CAS 13102-25-5), bis(4-maleimidophenyl)ketone, 1,1′-(benzene-1,3-diyldimethanediyl)bis(1H-pyrrole-2,5-dione) (CAS 13676-53-4), 4,4′-bis(maleimido)-1,1′-biphenyl (CAS 3278-30-6), 4,4′-bis(3-maleimidophenoxy)diphenylsulfone or maleimide-terminated thermoplastic polymers (D2) produced for example by reaction of amino-terminated thermoplastics (C2) with maleic anhydride, for example maleimide-terminated polysulfone ethers; and also mixtures of different maleimide resins (D2).

If the compositions of the invention contain polymerizable reactor resins (D), the molar ratio of the sum of the cyanate ester groups present in the composition of the invention to the sum of the reactive epoxide or imido functional groups in component (D) is preferably in the range from 10:90 to 99:1, more preferably from 30:70 to 95:5, in particular from 50:50 to 90:10.

If the compositions of the invention contain polymerizable imides (D2), it is preferable to add a further “coupler” component that is copolymerizable both with cyanate ester groups and with imido groups, preferably maleimido groups. These may be cyanate esters (A), modifiers (C3) or modifiers (C4) that have propenyl groups attached to aromatic carbon atoms; or aromatic hydrocarbon compounds containing per molecule one or more hydroxy groups attached to aromatic carbon atoms and also an imido group attached to an aromatic carbon atom, preferably a maleimido group, for example N-(4-hydroxyphenyl)maleimide (CAS 7300-91-6).

If the compositions of the invention contain polymerizable imide resin (D2), the molar ratio of the sum of the imido groups to the sum of the propenyl groups from components (A), (C3), and (C4) is within a range of preferably from 45:55 to 95:5, more preferably 60:40 to 90:10, in particular 65:35 to 80:20.

### Compound (E)

The fillers (E) used in the compositions of the invention may be any known fillers.

The fillers (E) used according to the invention are preferably ones that dissolve to an extent of less than 1% by weight in toluene at 23° C. and 1000 hPa.

Examples of fillers (E) are non-reinforcing particulate fillers, i.e. fillers having a BET surface area of preferably up to 50 m2/g, for example quartz, glass, cristobalite, diatomaceous earth; water-insoluble silicates, such as calcium silicate, calcium metasilicate, magnesium silicate, zirconium silicate, talc, mica, feldspar, kaolin, zeolites; metal oxides, such as aluminum, titanium, iron, boron or zinc oxides or mixed oxides thereof; barium sulfate, calcium carbonate, marble flour, gypsum, silicon nitride, silicon carbide, boron nitride, plastic powders such as polyacrylonitrile or polyetherimide powder; reinforcing fillers, i.e. fillers having a BET surface area of more than 50 m2/g, such as fumed silica, precipitated silica, precipitated chalk, carbon black, such as furnace black and acetylene black and silicon-aluminum mixed oxides having a large BET surface area; aluminum trihydroxide, magnesium hydroxide, hollow spherical fillers, such as glass microballoons, glass spheres, phenolic thermospheres or ceramic microspheres, for example those obtainable under the trade name Zeeospheres™ from 3M Deutschland GmbH, Neuss, Germany; fibrous fillers, such as wollastonite, montmorillonite, basalt, bentonite and chopped and/or ground glass fibers (short glass fibers) or mineral wool; metallic fibers, fibers composed of metal oxides, glass, ceramics, carbon or plastic; and natural fibers composed of cellulose, flax, hemp, wood or sisal.

For the production of high-performance composite materials, the resin compositions according to the invention preferably contain fiber reinforcement (E1) composed of any known fiber-forming materials, preferably from polypropylene, polyethylene, polytetrafluoroethylene, polyester; metallic fibers made of steel; oxidic and non-oxidic ceramics, such as silicon carbide, aluminum oxide, silicon dioxide, boron oxide; glass, quartz, carbon, aramid, asbestos, graphite, acrylonitrile, poly(benzothiazole), poly(benzimidazole), poly(benzoxazole), titanium dioxide, boron, and aromatic polyamide fibers, such as poly(p-phenylene terephthalamide). The fibers (E1) may be used in different forms, for example as continuous ropes, each having 1000 to 400 000 individual filaments, woven fabrics, noncrimp fabrics, knitted fabrics, braids, mats, nonwovens, whiskers, chopped or ground short fibers or random fiber felt. Preferred fibers are carbon fibers, aromatic polyamide fibers, ceramic fibers, and glass fibers.

The recited fillers (E) may optionally be surface-treated, for example hydrophobized, for example by treatment with organosilanes or organosiloxanes, stearic acid or with one or more modifiers (C). It is also possible for the filler surfaces to be modified to allow chemical bonding to the cured resin matrix, for example by oxidation or treatment with acids or bases. The fillers (E) are preferably surface-treated.

The fillers (E) used according to the invention may be used either individually or in any mixture with one another. If a mixture of different fillers (E) is used, it is preferably a mixture of fillers (E1).

If the composition of the invention contains fillers (E), the proportion of component (E) based on the uncured composite material is preferably 5% to 80% by weight, more preferably 10% to 70% by weight, in particular 15% to 60% by weight. Said fillers are preferably fibrous fillers (E1).

If the composition of the invention comprises both fiber reinforcement (E1) and non-fibrous fillers (E), the weight ratio of the components (E):(E1) is preferably not more than 50%.

### Compound (F)

The composition of the invention may be crosslinked in the presence of a curing accelerator (F1), such as those known from the prior art. Suitable curing accelerators (F1) are for example acids and bases, such as hydrochloric acid, phosphinic acid, phosphonic acid, phosphoric acid, aliphatic and aromatic amines, such as triethylamine, N,N-dimethylaniline, and pyridine; amidines, guanidines, and sodium hydroxide; halides, such as aluminum chloride, lithium chloride, boron fluoride, iron chloride, zinc chloride, zinc fluoride, tin chloride, cobalt chloride, and titanium chloride; and metalorganic compounds, such as metal alkoxides, metal carboxylates or metal chelate complexes of aluminum, copper, zinc, titanium, iron, manganese, cobalt, chromium or nickel. Examples of metalorganic compounds are cobalt(II) naphthenate, nickel(II) naphthenate, iron(III) naphthenate, copper(II) naphthenate, manganese(II) naphthenate, aluminum(III) naphthenate, zinc(II) naphthenate, zinc(II) octoate, zinc(II) acetylacetonate, iron(III) acetylacetonate, cobalt(II) acetylacetonate, chromium(III) acetylacetonate, aluminum(III) acetylacetonate, and copper(II) acetylacetonate.

If an accelerator (F1) is used for crosslinking the compositions of the invention, this is preferably a combination of a metalorganic compound and a co-accelerator having at least one active proton, more preferably a combination of a metalorganic compound and a phenol (C4), for example nonylphenol.

If the compositions of the invention contain accelerators (F1), the amounts involved are preferably 0.00001 to 5 parts by weight based on 100 parts by weight of component (A), metalorganic compounds (F1) more preferably being used in amounts of 0.0001 to 0.02 parts by weight based on 100 parts by weight of component (A).

If the compositions of the invention contain imido-containing organosilicon compounds (C1) or imide resin (D2), it is possible to use free radical-forming curing accelerators (F2) such as organic peroxides, for example dicumyl peroxide, di-tert-butyl peroxide, dibenzoyl peroxide, dilauroyl peroxide, 1,1-bis(tert-butylperoxy)cyclohexane, and tert-butyl perbenzoate; or azo compounds, such as azobis(isobutyronitrile); either alone or in addition to (F1). If the compositions of the invention contain free radical-forming curing accelerators (F2), the amounts involved are preferably 0.1 to 2 parts by weight based on 100 parts by weight of the sum of imido-containing modifier (C1) and imide resin (D2). It is preferable that no free radical-forming curing accelerators (F2) are used.

### Compound (G)

Examples of optionally used solvent (G) are aliphatic monohydric and polyhydric alcohols, such as methanol, ethanol, n-propanol, isopropanol, n-butanol, isobutanol, sec-butanol, ethane-1,2-diol, propane-1,2-diol, propane-1,3-diol, polypropylene glycol, polyethylene glycol, butane-1,2-diol, butane-1,3-diol, polybutylene glycol, and glycerol; ethers, such as methyl tert-butyl ether, di-tert-butyl ether, and di-, tri- or tetraethylene glycol dimethyl ether; saturated hydrocarbons, such as n-hexane, cyclohexane, n-heptane, n-octane, and isomeric octanes, such as 2-ethylhexane, 2,4,4-trimethylpentane, 2,2,4-trimethylpentane, 2-methylheptane and trichlorethylene, and mixtures of saturated hydrocarbons having boiling ranges between 60-300° C., as obtainable under the trade names Exxsol™, Hydroseal® or Shellsol®; aromatic solvents, such as benzene, toluene, styrene, o-, m- or p-xylene, solvent naphtha, dimethyl phthalate, diisobutyl phthalate, dicyclohexyl phthalate, mesitylene, and chlorobenzene; aldehyde acetals, such as methylal, ethylhexylal, butylal, 1,3-dioxolane, and glycerol formal; carbonates, such as 1,3-dioxolan-2-one, diethyl carbonate, dimethyl carbonate, dipropyl carbonate, propylene glycol carbonate, and ethylene carbonate; ketones, such as acetone, methyl isobutyl ketone, methyl ethyl ketone, methyl isoamyl ketone, diisobutyl ketone, acetone, and cyclohexanone; esters, such as ethyl acetate, n-butyl acetate, ethylene glycol diacetate, gamma-butyrolactone, 2-methoxypropyl acetate (MPA), dipropylene glycol dibenzoate, and ethyl ethoxypropionate; amides, such as N,N-dimethylformamide, N,N-dimethylacetamide, N-methyl-2-pyrrolidone, and N-ethyl-2-pyrrolidone; acetonitrile; and dimethyl sulfoxide.

Preferred solvents (G) are aromatic hydrocarbons and ketones.

If the compositions of the invention contain solvent (G), the amounts involved are preferably from 10 to 500 parts by weight, more preferably 50 to 300 parts by weight, in each case based on 100 parts by weight of the sum of the components (A) and (B). The compositions of the invention preferably contain no solvent (G).

### Compound (H)

The further constituents (H) optionally used according to the invention are preferably pigments, dyes, fragrances, processing aids, such as agents for influencing tack, lubricants, demolding agents, antiblocking agents or dispersants; stabilizers against hydrolysis, light, oxidation, heat, discoloration; flame retardants or plasticizers.

If the compositions of the invention contain further constituents (H), the amounts involved are preferably from 0.01 to 20 parts by weight, more preferably 0.1 to 10 parts by weight, in each case based on 100 parts by weight of the sum of components (A) and (B). The compositions of the invention preferably contain no further constituents (H).

The compositions of the invention are by preference those comprising
(A) at least one cyanate ester resin,
(B) at least one organosiloxane,
optionally (C) at least one modifier,
optionally (D) at least one reactive resin,
(E) at least one filler,
optionally (F) at least one curing accelerator,
optionally (G) at least one solvent, and
optionally (H) further constituents.

The compositions of the invention are preferably those comprising
(A) at least one cyanate ester resin,
(B) at least one organosiloxane,
(C) at least one modifier,
optionally (D) at least one reactive resin,
(E1) at least one fiber-reinforcing filler,
optionally (F) at least one curing accelerator,
optionally (G) at least one solvent, and
optionally (H) further constituents.

In a particularly preferred embodiment the compositions of the invention are those comprising
(A) at least one cyanate ester resin,
(B) at least one organosiloxane,
optionally (C) at least one modifier,
(D1) at least one epoxy resin,
(E1) at least one fiber-reinforcing filler,
optionally (F) at least one curing accelerator,
optionally (G) at least one solvent, and
optionally (H) further constituents.

The compositions of the invention are in particular those comprising
(A) at least one cyanate ester resin,
(B) at least one organosiloxane,
(C) at least one modifier,
(D1) at least one epoxy resin,
(E1) at least one fiber-reinforcing filler,
optionally (F) at least one curing accelerator,
optionally (G) at least one solvent, and
optionally (H) further constituents.

In a further particularly preferred embodiment, the compositions of the invention are those comprising
(A) at least one cyanate ester resin,
(B) at least one organosiloxane,
optionally (C) at least one modifier selected from the group (C1) to (C4), (D2) at least one maleimide resin,
(E1) at least one fiber-reinforcing filler,
optionally (F) at least one curing accelerator,
optionally (G) at least one solvent, and
optionally (H) further constituents,
with the proviso that at least one component (A), (C3) or (C4) having 1-propenyl or 2-propenyl groups directly attached to aromatic carbon atoms is present.

In a further especially preferred embodiment, the compositions of the invention are those comprising
(A) at least one cyanate ester resin,
(B) at least one organosiloxane,
(C4) at least one modifier (C4),
(C) optionally at least one further modifier selected from the group (C1) to (C3),
(D2) at least one maleimide resin,
(E1) at least one fiber-reinforcing filler,
optionally (F) at least one curing accelerator,
optionally (G) at least one solvent, and
optionally (H) further constituents.

The compositions of the invention contain no further components aside from components (A) and (B), the optionally used components (C) to (H), and any raw material-typical impurities, for example catalyst residues, such as sodium chloride or potassium chloride, impurities in technical grade cyanate ester resin monomers, and any reaction products of the employed components formed during mixing/during storage.

In the compositions according to the invention, the above-described components may each be used individually or in the form of a mixture of at least two of the respective components.

The compositions of the invention may be produced according to known processes, for example by mixing the individual components in any desired order and in known fashion.

The present invention further provides a process for producing the compositions of the invention by mixing the individual components in any desired order.

In the process according to the invention, mixing may be carried out at temperatures in the range from preferably 20 to 150° C., more preferably in the range from 50 to 130° C., in particular at temperatures of 60 to 120° C. Very particularly preferably, mixing is carried out at the temperature that results, when mixing at ambient temperature, from the temperature of the raw materials plus the temperature increase due to the energy input during mixing, it being possible to heat or cool the mixture as required.

The mixing may be carried out at the pressure of the ambient atmosphere, i.e. about 900 to 1100 hPa. It is also possible for mixing to be carried out under either intermittent or continuous reduced pressure, for example at 30 to 500 hPa absolute pressure, in order to remove volatiles and/or air, or at a positive pressure, such as at pressures of between 1100 hPa and 3000 hPa absolute pressure, especially in a continuous process mode, when these pressures are for example established in closed systems as a result of pressure during pumping and as a result of the vapor pressure of the employed materials at elevated temperatures.

The process of the invention may be performed continuously, discontinuously or semicontinuously, preferably discontinuously.

In a preferred embodiment of the process of the invention for producing the compositions, the individual components are mixed in any desired order, wherein the filler (F) used is component (F1).

The compositions of the invention may be used for all purposes for which organic reactive resin systems or prepolymers thereof have also previously been used for subsequent crosslinking in thermosets.

The compositions of the invention may be made into shaped articles by known processing techniques, for example by prepregging (from the melt, solution or suspension), transfer molding, filament winding, compression molding, powder coating, pultrusion or injection methods, such as resin transfer molding.

In one variant of the process of the invention, components (A) and (B) and the optional components (C), (D), (G), and (H) are preferably first mixed in any desired order to form a premix, after which component (E1), preferably ropes, woven fabrics, noncrimp fabrics, knitted fabrics or braids, is impregnated with the premix optionally under pressure and optionally degassed. In the case of multilayer woven fabrics or noncrimp fabrics (E1), impregnation and degassing may be performed on each layer individually or on all layers together.

In a further preferred variant of the process of the invention, components (A) and (B) and the optional components (C), (D), (G), and (H) are first mixed in any desired order to form a premix and then injected into a mold cavity containing the component (E1), preferably ropes, woven fabrics, noncrimp fabrics, knitted fabrics or braids, with degassing preferably carried out simultaneously with the injection process.

In a further preferred variant of the process of the invention, components (A) and (B) and the optional components (C), (D), (G), and (H) are first mixed in any desired order to form a premix, then applied to a release paper, after which component (E1), preferably oriented ropes, woven fabrics, noncrimp fabrics, knitted fabrics or braids, is pressed between two coated paper sheets and passed through a series of heated rollers to ensure complete wetting of component (E1).

The compositions of the invention may be brought into any desired shape through mechanical pressure at ambient temperature or optionally at elevated temperature.

The compositions of the invention are preferably shapable and are more preferably fashioned and cured in a mold cavity or around a molding template.

The present invention therefore further provides for the use of the composition of the invention for producing shaped articles.

The present invention therefore further provides a process for producing shaped articles by shaping the composition and curing.

The invention therefore further provides shaped articles obtainable from the compositions of the invention by shaping and curing.

The compositions of the invention/produced according to the invention undergo crosslinking by cyclotrimerization of the cyanate ester groups from (A), optionally (C1), and optionally (C3) to afford 1,3,5-triazine units, optionally in the presence of an accelerator (F1); and optionally additionally by cyclotrimerization and cyclotetramerization of carbon-carbon triple bonds, addition reaction, Alder-ene reaction, Diels-Alder cycloaddition, and polymerization, wherein intramolecular rearrangements, isomerizations, and rearomatization steps may also occur. If the curing according to the invention additionally proceeds also by an addition reaction and optionally rearrangement, the epoxy groups from (C1) and (D1), if present, and the cyanate ester groups from (A) cyclized into triazine units react preferably with one another and/or with the hydroxy groups from (C1), (C2), (C4), and “coupler” components, if present, which contain per molecule one or more hydroxy groups attached to aromatic carbon atoms and also an imido group attached to an aromatic carbon atom, for example N-(4-hydroxyphenyl)maleimide, react preferably with the cyanate ester groups from (A). If the curing according to the invention additionally proceeds also by cyclotrimerization and cyclotetramerization of carbon-carbon triple bonds, the reactive carbon-carbon triple bonds of imide (D2) and/or modifier (C1), if present, react preferably with one another. If the curing according to the invention additionally proceeds also by polymerization, the reactive nadimido or maleimido groups, if present, or the carbon-carbon triple bonds of imide resin (D2) and/or modifier (C1) react preferably with one another, wherein the polymerization may be followed optionally by rearrangements and optionally by cycloaddition reactions. If the curing according to the invention additionally proceeds also by an Alder-ene or Diels-Alder reaction, the reactive groups of imide resin (D2), if present, particularly preferably maleimide resin (D2), and the 1-propenyl and 2-propenyl groups from (A), (C1), (C3) and/or (C4), if present, react preferably with one another, this being particularly preferably followed by further Diels-Alder reactions and rearomatization steps.

The mixtures according to the invention/produced according to the invention are preferably degassed before curing, more preferably after shaping and before curing.

The crosslinking according to the invention is carried out preferably at temperatures in the range from 50 to 350° C., more preferably from 100 to 300° C., in particular from 120 to 270° C. Very particularly preferably, the crosslinking according to the invention is carried out in a stepwise manner at temperatures of 120 to 270° C.

Crosslinking can be accelerated by increasing the temperature, which means it is also possible to carry out shaping and crosslinking in a single step.

The shaped articles according to the invention are preferably fiber composite materials (or fiber-reinforced plastics “FRP”).

The present invention further provides a process for producing fiber composite materials, characterized in that the compositions of the invention are shaped and crosslinked.

The compositions of (A) and (B) according to the invention preferably cure to form macroscopically homogeneous/single-phase, transparent thermosets.

The compositions of the invention may be solid or liquid at a temperature of 100° C. and an air pressure of 1013 hPa and are preferably liquid at 100° C. and 1013 hPa.

If the compositions of the invention are liquid at 100° C. and 1013 hPa, they have a dynamic viscosity of preferably more than 1 and less than 5000 mPa·s, preferably more than 1 and less than 2000 mPa·s, more preferably more than 1 and less than 1000 mPa·s, especially more than 1 and less than 500 mPa·s, in each case at 100° C. and 1013 hPa.

In the context of the present invention, dynamic viscosity is determined according to DIN 53019 at a temperature of 23° C. and an air pressure of 1013 hPa unless otherwise stated. The measurement is performed on a “Physica MCR 300” rotational rheometer from Anton Paar. A coaxial cylinder measuring system (CC 27) having an annular measuring gap of 1.13 mm is used for viscosities of 1 to 200 mPa·s and a cone-plate measuring system (Searle system with CP 50-1 measuring cone) used for viscosities greater than 200 mPa·s. The shear rate is adjusted to the polymer viscosity (1 to 99 mPa·s at 100 s-1; 100 to 999 mPa·s at 200 s-1; 1000 to 2999 mPa·s at 120 s-1; 3000 to 4999 mPa·s at 80 s-1; 5000 to 9999 mPa·s at 62 s-1; 10 000 to 12 499 mPa·s at 50 s-1; 12 500 to 15 999 mPa·s at 38.5 s-1; 16 000 to 19 999 mPa·s at 33 s-1; 20 000 to 24 999 mPa·s at 25 s-1; 25 000 to 29 999 mPa·s at 20 s-1; 30 000 to 39 999 mPa·s at 17 s-1; 40 000 to 59 999 mPa·s at 10 s-1; 60 000 to 149 999 at 5 s-1; 150 000 to 199 999 mPa·s at 3.3 s-1; 200 000 to 299 999 mPa·s at 2.5 s-1; 300 000 to 1 000 000 mPa·s at 1.5 s-1.

After thermally equilibrating the measuring system at the measurement temperature, a three-stage measurement program consisting of a run-in phase, preshearing, and a viscosity measurement is employed. The run-in phase involves gradually increasing the shear rate over one minute to the shear rate at which the measurement is to be made and which corresponds to the expected viscosity as stated above. Once said shear rate has been attained, preshearing is carried out at a constant shear rate for 30 s, followed for the viscosity determination by the performance of 25 individual measurements for 4.8 s each, the results of which are averaged. The average value corresponds to the dynamic viscosity, which is reported in mPa·s.

After storage in water at 240° C. for 200 hours, the cured thermoset compositions of the invention comprising 85% by weight (A) and 15% by weight (B) exhibit a weight loss that is by preference not more than 100%, preferably not more than 90%, more preferably not more than 80%, in particular not more than 70%, higher than that of the corresponding unmodified cyanate ester resins (A).

After storage in water at 70° C. for 2000 hours, the cured thermoset compositions of the invention comprising 85% by weight (A) and 15% by weight (B) exhibit a water absorption that is by preference at least 20%, preferably at least 30%, more preferably at least 40%, in particular at least 50%, lower than that of the corresponding unmodified cyanate ester resins (A).

The ratio of the flexural modulus of elasticity E of the cured compositions of (A) and (B) of the invention to the respective cured, unmodified cyanate ester resin (A) is preferably 0.5 to 1.0, more preferably 0.5 to 0.95, in particular 0.6 to 0.85, in each case measured at 23° C.

The ratio of the critical stress intensity factor K_{Ic} of the cured compositions of (A) and (B) of the invention to the respective cured, unmodified cyanate ester resin (A) is greater than 1.0, more preferably greater than 1.1, in particular greater than 1.2, in each case measured at 23° C.

The cured compositions of the invention have the advantage that they exhibit markedly reduced water absorption and thus better hydrolysis resistance.

The shaped articles according to the invention have the advantage that they are thermally stable and have a reduced fire load compared to composite materials made from purely organic cyanate ester resin systems.

The shaped articles according to the invention have the advantage that they exhibit high thermal stability.

The compositions of the invention have the advantage that they allow the production of so-called composites having high temperature resistance, a high glass transition temperature, high stiffness, and high fracture toughness as expressed by the critical stress intensity factor (K_{Ic}).

The compositions of the invention have the advantage that they are producible from readily obtainable raw materials and in a simple manner.

The compositions of the invention have the advantage that their processing does not result in harmful emissions to the extent typically occurring with organic cyanate ester resins used according to the prior art.

### EXEMPLARY EMBODIMENTS

The examples that follow describe how the present invention may be performed in principle but without this limiting said invention to what is disclosed therein.

The examples that follow were performed at a pressure of the ambient atmosphere, i.e. at about 1013 hPa, and at room temperature, i.e. about 23° C., or at a temperature established upon combining the reactants at room temperature without additional heating or cooling.

### Molar Masses

In the context of the present invention, the weight-average molar mass Mw and number-average molar mass Mn, in each case in units of g/mol and rounded to the nearest 10 in accordance with DIN 1333:1992-02, section 4, are determined by size-exclusion chromatography (SEC/GPC) in accordance with DIN 55672-1/ISO 160414-1 and ISO 160414-3 with tetrahydrofuran (THF) as eluent by calibrating against polystyrene standards a column array based on polystyrene-co-divinylbenzene as the stationary phase and made up of three columns of different pore size distribution in the sequence 10 000 Å, 500 Å, and 100 Å, said array having a size cutoff of max. 450 000 g/mol. The analyses are performed at a column temperature of 40±1° C. and using a refractive index detector.

### Production of the Test Specimens

The cyanate ester resin (A) was first heated to 100° C. with thorough mixing for better processability. Organosiloxane (B) was then added and the mixture homogenized at 120° C. for one hour, after which it was degassed at a pressure of 10 mbar for one hour at 120° C. and, after releasing the vacuum with nitrogen, immediately poured while hot into a 2-part screw-closure aluminum mold preheated to 160° C.; the mold cavity dimensions were 100 mm×12.7 mm×2.5 mm (length×width×height) for producing the test specimens for the flexural test and 200 mm×100 mm×6.5 mm (length×width×height) for producing the test specimens for determining fracture toughness, water absorption, and thermooxidative stability. To prevent sticking and leakage, the mold cavity surface was treated on the inside of the mold with a polytetrafluoroethylene spray and a 2 mm-thick round cord made of fluororubber having a hardness of 75 Shore A was placed around the mold cavity. For curing, the filled molds were stored in a convection oven according to the following temperature program:
1) 18 hours curing at 180° C.
2) Temperature increase over 30 minutes to 200° C.
3) 3 hours curing at 200° C.
4) Temperature increase over 30 minutes to 240° C.
5) 2 hours curing at 240° C.

The test specimens were then allowed to cool in the molds to ambient temperature before being demolded. For further use, the uppermost 10 mm of the vulcanizate side, which was open and exposed to air during curing in the mold, was cut off and discarded. The test specimens for the measurement of fracture toughness, water absorption, and thermooxidative stability were then cut out of the large vulcanizate slab 6.5 mm in height using a diamond saw in the appropriate dimensions of length×width such that all four lateral surfaces of the test specimens 6.5 mm in height were sawn surfaces; the test specimens 1.00 mm in thickness for measuring water absorption were cut out of the pre-sawn piece using a diamond hole saw such that all six surfaces of these test specimens were sawn surfaces.

### Fracture Toughness K_{Ic}

The measurement of fracture toughness/critical stress intensity factor K_{Ic} was performed as described in the publication “Reactive and Functional Polymers 142 (2019) 159-182” at 23° C. and 50% relative humidity; the thickness of the specimens for this was 6.5 mm. The value for fracture toughness K_{Ic} reported in Table 1 in MN×m^{-3/2} was rounded to two decimal places in accordance with DIN 1333: 1992-02, section 4.

### Flexural Modulus of Elasticity E

In the present invention, the flexural modulus of elasticity was measured according to ISO 178:2011-04, method A, with a test speed of 2 mm/min and at a contact distance L of 38 mm. The measurements were performed at 23° C. and 50% relative humidity. Cuboidal test specimens having the dimensions length×width×thickness=60.0 mm×12.7 mm×2.5 mm were used. The measurements were each time performed on 5 test specimens. The value reported in Table 1 for the flexural modulus of elasticity E in GPa is in each case the average of the individual measurements rounded to one decimal place in accordance with DIN 1333:1992-02, section 4.

### Water Absorption

In the present invention, the gravimetric determination of water absorption employed cuboidal test specimens having the dimensions length×width×thickness=30.00 mm×17.00 mm×1.00 mm; the precision of the weight determination was ±0.01 mg. The test specimens were first dried to constant weight in a vacuum oven at 70° C. and 30 mbar, with the weight determined at intervals of 24 hours. The test specimens were considered “dry” if no further weight loss was measured over a period of 48 hours. One dry test specimen was in each case then immersed in 45 ml of deionized water in a suitable sealable vessel; the sealed vessel was then placed in a convection oven preheated to 70° C. and maintained at this temperature throughout the test period. After 2000 hours the test specimens were removed, cooled to ambient temperature, and the surfaces wiped dry with a cloth; the weight of the test specimens was then redetermined. The water absorption was calculated according to

$$( \frac{Weight after storage in water in g}{\begin{matrix}Gewicht nach Trocknung und vor WasWeight \\ after drying and before storage in water in g\end{matrix}} - 1 ) ;$$

Table 1 reports the value for the water absorption in % and rounded to two decimal places in accordance with DIN 1333: 1992-02, section 4.

### Thermooxidative Stability

In the present invention, the gravimetric determination of thermooxidative stability employed cuboidal test specimens having the dimensions length×width×thickness=12.00 mm×6.50 mm×6.50 mm; the precision of the weight determination was ±0.01 mg. The test specimens were first dried to constant weight in a vacuum oven at 70° C. and 30 mbar, with the weight determined at intervals of 24 hours. The test specimens were considered “dry” if no further weight loss was measured over a period of 48 hours. The test specimens were then stored in a convection oven at 240° C. After 200 hours the test specimens were removed and the weight of the test specimens redetermined. The decrease in weight was calculated according to

$$( \frac{Weight after storage at 240 ° C . in g}{W eight after drying and before storage at 240 ° C . in g} - 1 ) ;$$

Table 1 reports the value for the decrease in weight in % and rounded to two decimal places in accordance with DIN 1333:1992-02, section 4.

### Compatibility

The compatibility of the cured cyanate ester matrix with the siloxane modifier was assessed directly after curing using the test specimens produced. In Table 1 the compatibility is indicated as “+”=good compatibility (test specimen homogeneous/single phase, transparent, no weeping or exudation of the siloxane component from the vulcanizate), “o”=average compatibility (test specimen cloudy to opaque, surfaces dry, no weeping or exudation of the siloxane component from the vulcanizate) and “−”=poor compatibility (test specimen opaque, surfaces oily or tacky, visible weeping or exudation of the siloxane component from the vulcanizate).

### Example B1

85 g of 2,2-bis(4-cyanatophenyl)propane (CAS 1156-51-0; commercially available from TCI Deutschland GmbH, D-65760 Eschborn) as component (A) and 15 g of 1,1,3,5,5-pentaphenyl-1,3,5-trimethyltrisiloxane (CAS 3390-61-2; commercially available from abcr GmbH, D-76187 Karlsruhe) as component (B) were mixed together as described under “Production of the test specimens”, poured into molds, and cured.

### Comparative Example C1

The procedure described in example 1 was repeated with the modification that no 1,1,3,5,5-pentaphenyl-1,3,5-trimethyltrisiloxane as component (B) was added to component (A).

### Comparative Example C2

The procedure described in example 1 was repeated with the modification that 1,1,5,5-tetramethyl-3,3-diphenyltrisiloxane (CAS 17875-55-7; commercially available from TCI Deutschland GmbH, D-65760 Eschborn) was added to component (A) instead of 1,1,3,5,5-pentaphenyl-1,3,5-trimethyltrisiloxane.

### Comparative Example C3

The procedure described in example 1 was repeated with the modification that a poly(methylphenylsiloxane) having an average composition of Me₃SiO_{1/2})_{0.12}(MePhSiO_{2/2})_{0.88}, a weight-average molar mass Mw of 2150 g/mol, and a number-average molar mass Mn of 1380 g/mol (CAS 9005-12-3; commercially available from ABCR, 76187 Karlsruhe) was added to component (A) instead of 1,1,3,5,5-pentaphenyl-1,3,5-trimethyltrisiloxane.

### Comparative Example C4

The procedure described in example 1 was repeated with the modification that a poly(methylphenylsiloxane) having an average composition of Me₃SiO_{1/2})_{0.30}(MePhSiO_{2/2})_{0.70}, a weight-average molar mass Mw of 800 g/mol, and a number-average molar mass Mn of 700 g/mol was added to component (A) instead of 1,1,3,5,5-pentaphenyl-1,3,5-trimethyltrisiloxane.

### Comparative Example C5

The procedure described in example 1 was repeated with the modification that a hydroxy-terminated poly(dimethylsiloxane-diphenylsiloxane) copolymer having an average composition of (MezSiO_{1/2})_{0.80}(Ph₂SiO_{2/2})_{0.09}(Me₂Si(OH)O_{1/2})_{0.03}(Ph₂Si(OH)O_{1/2})_{0.08}, a weight-average molar mass Mw of 1930 g/mol, and a number-average molar mass Mn of 940 g/mol was added to component (A) instead of 1,1,3,5,5-pentaphenyl-1,3,5-trimethyltrisiloxane.

TABLE 1

| Example | B1 | C1 | C2 | C3 | C4 | C5 |
|---|---|---|---|---|---|---|
| Compatibility | + | + | + | − | − | − |
| Flexural modulus of elasticity E | 2.4 | 2.9 | 2.4 | *¹ | *² | *³ |
| at 23° C. [GPa] | | | | | | |
| Stress intensity factor K_{Ic} | 0.61 | 0.51 | 0.45 | *¹ | *² | *³ |
| at 23° C. [MN × m^{-3/2}] | | | | | | |
| Water absorption at 70° C. | 1.35 | 3.13 | 2.30 | *¹ | *² | *³ |
| after 2000 hours [%] | | | | | | |
| Thermooxidative stability, | 1.91 | 1.30 | 2.23 | *¹ | *² | *³ |
| decrease in weight at 240° C. | | | | | | |
| after 200 hours [%] | | | | | | |

*¹ no measurement, as poor compatibility (strong exudation).
*² no measurement, as poor compatibility (exudation and tacky vulcanizate surface).
*³ no measurement, as poor compatibility (exudation and numerous superficial depressions and also gas bubble inclusions in the vulcanizate).

1-11. (canceled)

12. A crosslinkable composition comprising
(A) at least one organic compound free of siloxane units (=“≡Si—O—Si≡”) and having at least two reactive cyanate ester groups (=“N≡CO—”),
(B) at least one linear organosiloxane of general formula 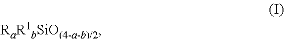
where
R may be identical or different and represents monovalent, SiC-bonded, saturated aliphatic hydrocarbon radicals,
R¹ may be identical or different and represents monovalent, SiC-bonded, optionally halogen- or phosphorus-substituted, aromatic hydrocarbon radicals,
a is 0, 1, 2 or 3,
b is 0, 1, 2 or 3,
with the proviso that
the organosiloxane (B) consists of three to five units of formula (I),
in formula (I) the sum a+b is equal to 2 or 3,
in each molecule of organosiloxane (B) the sum a+b is in two units of formula (I) equal to 3 and in each molecule of organosiloxane (B) there are at least three radicals R¹ present.

13. The crosslinkable composition as claimed in claim 12, wherein the composition further a comprises (E) at least one filler.

14. The crosslinkable composition as claimed in claim 12, wherein the composition further comprises (C) at least one modifier and (E1) at least one fiber-reinforcing filler.

15. The crosslinkable composition as claimed in claim 12, wherein the composition further comprises (D1) at least one epoxy resin and (E1) at least one fiber-reinforcing filler.

16. The crosslinkable composition as claimed in claim 12, wherein the composition further comprises (C) at least one modifier, (D1) at least one epoxy resin, and (E1) at least one fiber-reinforcing filler.

17. The crosslinkable composition as claimed in claim 12, wherein the composition further comprises optionally (C) a modifier selected from the group (C1) to (C4), (D2) at least one maleimide resin, (E1) at least one fiber-reinforcing filler,
with the proviso that at least one component (A), (C3) or (C4) having 1-propenyl or 2-propenyl groups directly attached to aromatic carbon atoms is present.

18. The crosslinkable composition as claimed in claim 12, wherein the composition further comprises (C4) at least one modifier, (D2) at least one maleimide resin, (E1) at least one fiber-reinforcing filler.

19. A process for producing the crosslinkable composition as claimed in claim 12 by mixing the individual components in any desired order.

20. A process for producing shaped articles by shaping the crosslinkable composition as claimed in claim 12 and subsequent curing.

21. The use of the crosslinkable composition as claimed in claim 12 for producing shaped articles.

22. A shaped article obtainable from the process as claimed in claim 20.
